(19) United States
(12) Patent Application Publication
(10) Pub. No.: US 2024/0036522 A1
(43) Pub. Date: Feb. 1, 2024

(54) METHOD FOR MANUFACTURING A HOROLOGICAL COMPONENT

(71) Applicant: ROLEX SA, Geneva (CH)

(72) Inventors: Florian Calame, Epalinges (CH); Valentin Gäumann, Saint-Prex (CH)

(73) Assignee: ROLEX SA, Geneva (CH)

(21) Appl. No.: 18/357,096

(22) Filed: Jul. 21, 2023

(30) Foreign Application Priority Data
Jul. 28, 2022 (EP) 22187582.6

(51) Int. Cl. G04B 45/00; G04B 19/04

(52) U.S. Cl. CPC G04B 45/0061; G04B 19/042

(57) ABSTRACT

The method for manufacturing a horological component (1) having at least one portion having a surface (11), in particular a top surface, includes: engraving (E3) the surface (11) of the horological component (1) or of a blank (1a) of the horological component (1) to form at least one cavity (7); depositing (E7) a metal or metal alloy layer (22) on the surface (11), both in the at least one cavity (7) and outside of the at least one cavity (7); and engraving a material (E4) on the metal or metal alloy layer (22), at least within the at least one cavity (7), to form a layer of material (8), this material being different from the metal or the metal alloy of the metal or metal alloy layer (22), and forming an adhesion layer of the layer of material (8).

This application claims priority of European patent application No. EP22187582.6 filed Jul. 28, 2022, the content of which is hereby incorporated by reference herein in its entirety.

The present invention relates to a method for manufacturing a horological component. It relates also to a horological component as obtained by such a manufacturing method.

### BACKGROUND ART

Different decoration and/or marking methods are implemented on external part components of a timepiece. With respect to these external part components, a horological movement component is often of smaller dimension, and comprises functional parts of very precise geometry, that must in no circumstances be deteriorated. Thus, it is very difficult to produce a marking on such a horological movement component, for example for the purpose of identification or of decoration.

### SUMMARY OF THE INVENTION

Thus, the object of the present invention is notably to find a solution for marking and/or decorating a horological component, in particular a horological movement component, which makes it possible to achieve a particularly attractive visual effect without damaging the functionality of the component.

To this end, the invention relies on a method for manufacturing a horological component comprising at least one portion comprising a surface, in particular a top surface, characterized in that it comprises at least the following steps:
engraving said surface of the horological component or of a blank of the horological component to form at least one cavity;
depositing a metal or metal alloy layer on said surface both in the at least one cavity and outside of the at least one cavity;
depositing a material on said metal or metal alloy layer, at least within the at least one cavity, to form a layer of material, this material being different from the metal or the metal alloy of said metal or metal alloy layer, this metal or metal alloy layer forming an adhesion layer of said layer of material.

The invention is more particularly defined by the claims.

### BRIEF DESCRIPTION OF THE DRAWINGS

These objects, features and advantages of the present invention will be explained in detail in the following description of particular embodiments given in a nonlimiting manner in relation to the attached figures in which:

FIGS. 1a to 1g illustrate the successive steps of a method for manufacturing a spiral spring of a horological movement according to an embodiment of the invention.

FIG. 2 illustrates a flow diagram schematically representing the steps and substeps of a method for manufacturing a horological component according to an embodiment of the invention.

FIG. 3 represents a top view of a spiral spring produced by a manufacturing method according to an embodiment of the invention.

### DETAILED DESCRIPTION OF PARTICULAR EMBODIMENTS

The invention implements a method for manufacturing a horological component which advantageously combines at least one engraving step and one step of colouring of said engraving obtained, so as to obtain a visible engraving that does not impact the functional performance of a movement component.

To simplify the reading of the patent application, the same references will be used in the different embodiments and their variants in order to denote the same features. The manufacturing method according to an embodiment of the invention will be illustrated in the context of the manufacturing of a horological movement component, which can for example be a spiral spring.

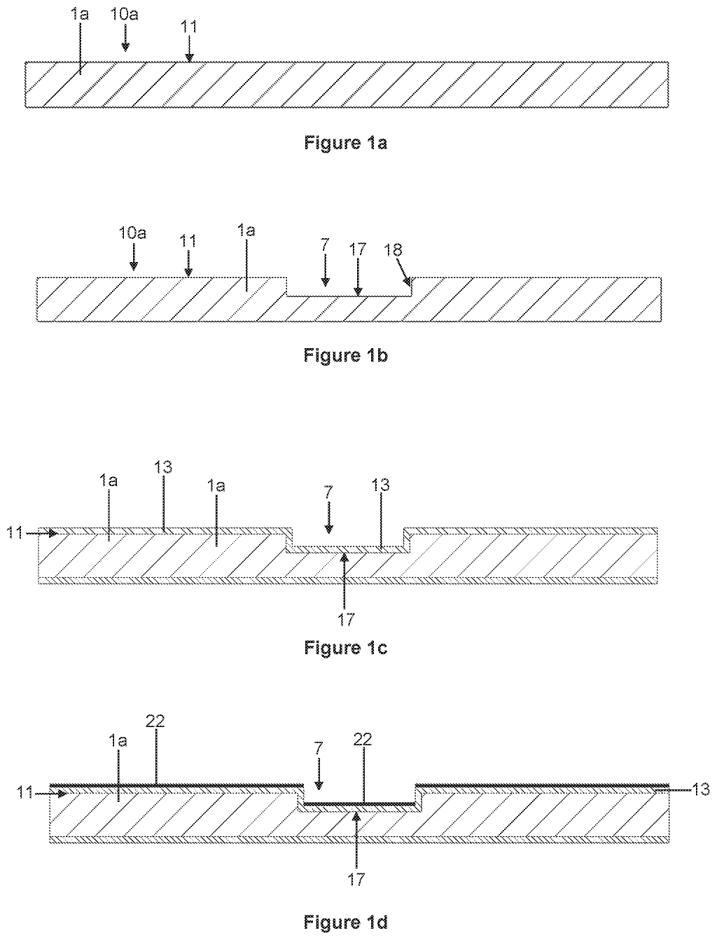

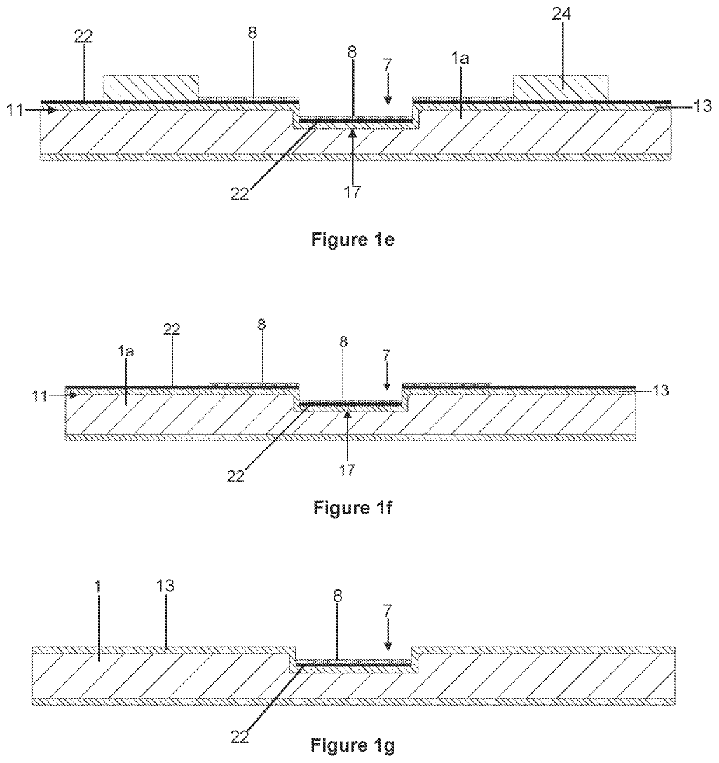

FIGS. 1a to 1g illustrate more particularly cross-sectional views of a horological component 1, notably a horological movement component, or of a blank 1a of the horological component 1, during the various steps of the manufacturing thereof according to an embodiment of a method for manufacturing the horological component. The manufacturing method of the invention more particularly addresses a specific manufacturing phase, relating to a method of engraving a surface. Advantageously, this is a method for engraving a visible surface or a top surface of the horological component 1, notably for decorative purposes. Alternatively, it could also relate to a method for engraving a non-visible surface or a bottom surface, notably for identification or marking purposes.

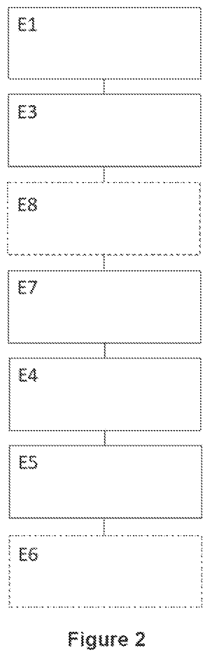

According to this embodiment illustrated by FIGS. 1a to 1g, the method comprises a first step consisting in making available E1 at least one portion of a horological component 1 or of a blank 1a of the horological component 1, specifically represented in cross section in FIG. 1a. Note that, according to this advantageous embodiment, several blanks 1a can be linked to a same support or substrate 10a, and be simultaneously subjected to the method which will be described hereinbelow and the steps of which are summarized by the flow diagram of FIG. 2.

The horological component blanks 1a can therefore be manufactured by micro-manufacturing operations from a substrate 10a, which preferably takes the form of a micro-machinable material or is based on micro-machinable material. Note that hereinbelow the term blank will be used in the broad sense, to denote any intermediate element in the method for manufacturing the horological component. Thus, the blank can be a simple substrate made available and not yet engraved, or a substrate that is already partially engraved, for example to define all or part of the outline of the future horological component. To simplify the description, the terms blanks 1a or horological component 1 will alternatively be used to denote the same component, even if the horological component 1 is still being manufactured.

The portion of the blank 1a on which the invention is implemented comprises a surface 11 which will be specifically treated by the method according to the invention, in order to create visible patterns or indications on this surface 11, as will be detailed hereinbelow.

The substrate 10a can be made of a micro-machinable material or be based on a micro-machinable material. The substrate can wholly or partly comprise silicon, in any form. It can thus comprise monocrystalline silicon regardless of its orientation, polycrystalline silicon, amorphous silicon, amorphous silicon dioxide, doped silicon regardless of the type and level of doping. It can notably take the form of a SOI (silicon on insulator) substrate. Alternatively, it can comprise quartz, diamond, glass, ceramic, ruby, sapphire, or silicon carbide. Alternatively, it can be made of metal or of a metal alloy, notably an at least partially amorphous metal alloy. For example, it can comprise nickel or nickel-phosphorus, or even steel, titanium, an alloy of gold, or a platinoid alloy.

FIG. 1b illustrates a second step of the method consisting in engraving E3 said surface 11 of the horological component 1 or of a blank 1a of the horological component 1 to form at least one cavity 7. According to a preferred embodiment, the engraving is performed by the deep reactive ion etching (DRIE) technology. This technique makes it possible to form cavities 7 with side walls 18 that are vertical or substantially vertical in line with the openings of a layer of resin forming a mask, without impacting the zones of the surface 11 covered by the layer of resin. More specifically, the engraving step etches the silicon, so as to form at least one cavity 7. Each cavity 7 has a section of substantially rectangular form, delimited by a surface forming a bottom 17, substantially parallel to the surface 11 of the component. The depth of a cavity is measured at right angles to the surface 11, and corresponds to the respective distance between the planes of the surface 11 and of the bottom 17 of the cavity. More generally, the at least one cavity 7 has side walls 18 advantageously forming a discontinuity relative to the rest of the surface 11 of the blank 1a.

Advantageously, the depth of at least one or all of the cavities 7 is less than 10 μm. More advantageously, this depth is preferentially equal to or greater than the thickness of a layer of silicon dioxide 13, which is optional.

According to this preferred embodiment, such a step consisting in engraving E3 by deep reactive ion etching also makes it possible to obtain a bottom 17 whose surface texture is notably characterized by a particularly low roughness, notably with a bottom 17 having a roughness Ra less than 50 nm, preferentially of the order of 20 nm, or less than 20 nm, and/or a roughness Sa less than 100 nm, preferentially of the order of 80 nm, or less than 80 nm, which makes it possible to reveal the flash of the layer of material deposited subsequently on such a bottom 17, as will be explained.

Also, this step consisting in engraving E3 the surface 11 of the horological component 1 is advantageously performed in a same operation as a step consisting in engraving an outline of said horological component 1. As a variant, this step consisting in engraving E3 said surface of the portion of said horological component 1 can be performed before a step consisting in engraving an outline of said horological component 1. In these cases, the method can comprise a step of positioning of a first mask, not represented, on the substrate 10a, notably on said surface 11 of said substrate 10a, so as to perform the step consisting in engraving E3 at least one cavity 7 from this first mask, notably a blind engraving, using the deep reactive ion etching (DRIE) technology, and a step of positioning of a second mask, not represented, on said substrate 10a, notably on another surface of said substrate 10a, so as to engrave an outline of the blank 1a of the horological component 1 from this second mask. In other words, the engraving used to cut the component from the substrate and the engraving forming at least one cavity according to the invention can be performed in one and the same operation, or partially in one and the same operation. These two engravings are performed from different masks.

It can thus be advantageous to use a deep reactive ion etching (DRIE) for a component notably comprising silicon, quartz, glass or diamond.

As a variant, the engraving can comprise the implementation of a laser etching, notably by a femtosecond laser.

The method then comprises, in an embodiment of use of a substrate 10a wholly or partly comprising silicon, an optional step consisting in oxidizing E8 the surface of the blank 1a. As illustrated by FIG. 1c, the surface 11 of the blank 1a then comprises a layer of silicon dioxide (SiO₂) 13. This layer of silicon dioxide 13 is notably formed on the top surface 11, including at least a bottom 17 of a cavity 7. In other words, this layer of silicon dioxide 13 is notably formed on the top surface 11 and on a bottom 17 of a cavity.

The method then comprises a step consisting in depositing E7 a metal or metal alloy layer 22 on said surface 11 of the blank 1a, both in the at least one cavity 7, more specifically on the bottom 17 of the at least one cavity 7, and outside of the at least one cavity 7.

According to this embodiment illustrated by FIGS. 1a to 1g, this metal or metal alloy layer 22 is a layer of chromium. As a variant, the metal or metal alloy can be made of aluminium, or of titanium, or of an alloy of aluminium, of chromium or of titanium.

This step consisting in depositing E7 the metal or metal alloy layer 22 can be performed by a directional deposition, notably a physical vapour phase deposition (PVD), notably by a deposition by electron beam evaporation (EBE). Thus, advantageously, the metal or metal alloy layer 22 is deposited so as to avoid any deposition of material on the side walls 18 of the cavities 7, which are, here, at right angles or substantially at right angles to the bottom 17. The result of this step is illustrated by FIG. 1d. As a variant, the metal or metal alloy layer 22 could extend only over a negligible part of the side walls 18, notably a lower part extending from the bottom 17, for example a lower part extending from the bottom 17 over a distance less than 1 μm, and not reaching the boundary with the surface 11 outside of the cavity 7.

Also, it is found that the sacrificial layer function of this metal or metal alloy layer 22, which will be detailed hereinbelow, is optimal for small thicknesses of this layer, notably a thickness less than or equal to 100 nm.

The method then implements a fourth step consisting in depositing a material E4 on the surface of the component, more specifically on the metal or metal alloy layer 22, at least in the at least one cavity 7 and possibly on the surface 11 outside of the cavity 7. According to the embodiment illustrated by FIGS. 1a to 1g, the material is a metal or a metal alloy, and this step of deposition forms at least one layer of metal or metal alloy material 8, as represented by FIG. 1e. It is more particularly one and the same layer of gold 8 on FIG. 1e.

Preferentially, the material is a metal forming part of the group comprising Au, Ag, Cr, CrN, Ni, Pt, TiN, ZrN, Pd or the alloys thereof, unless incompatible with the metal or metal alloy layer 22. In another variant, this material could not be metallic, as will be specified hereinbelow.

The thickness of this at least one layer of material 8 can be of the order of a few nanometres. It is preferably at least 5 nm, even at least 10 nm, even at least 50 nm, even at least 100 nm. More particularly, it is preferably between 5 nm and 1000 nm, even between 100 nm and 1000 nm. A thickness of between 100 nm and 200 nm forms a good solution, as will be described hereinbelow.

The step of deposition of a material E4 can comprise the deposition of a single and unique layer. Alternatively, this step of deposition can comprise the successive deposition of two or more distinct layers.

According to one embodiment, the material deposition step E4 is performed by a directional deposition, notably by a physical vapour deposition (acronym PVD), notably by electron beam evaporation (EBE). More generally, this deposition can be a vapour phase deposition, such as the abovementioned physical deposition (PVD) or a chemical deposition (CVD) or an atomic deposition (ALD).

Optionally, the material deposition step E4 can comprise a first substep prior to the application of a mask 24, for example a rigid mask or a stencil, such as a mask 24 made of silicon, to reduce the extent of the surface 11 affected by the deposition of the layer of material 8 on the metal or metal alloy layer 22 around the cavity or cavities 7, in order to favour the subsequent step of removal E5 of the metal or metal alloy layer 22, which will be described hereinbelow. According to a first variant, the pattern of the mask 24 can correspond exactly to the patterns of the cavities 7 so as to deposit the material only in the cavities 7. However, according to a second, simpler variant, the pattern of the mask 24 does not need to exactly match the pattern formed by the cavities 7 on the surface 11, and can show a narrow surface area of the surface of the component around the cavities, as represented by FIG. 1e. In this latter case, a layer of material 8 is also deposited outside of the cavities 7, on the surface of the component. In other words, in all cases, the mask 24 comprises at least one opening superposed on the at least one cavity 7, of a surface area greater than or equal to the surface area of the cavity, so as not to cover the at least one cavity. In this embodiment, the mask 24 therefore delimits a reduced surface area relative to the total surface area 11 of the portion of component considered, on which the material deposition is performed. The material deposition step E4 also comprises a final, second substep of removal of the mask 24, after the end of the deposition of the material, to achieve the result represented by FIG. 1f.

Note that, in FIG. 1f, the metal or metal alloy layer 22 deposited on the surface of the component separate this surface from the layer of material 8. This metal or metal alloy layer 22 thus fulfils a first function of separation with respect to the deposition of material.

The method then comprises a step consisting in removing E5 the metal or metal alloy layer 22 deposited outside of said at least one cavity, notably by selective chemical attack. Indeed, this step can implement a lift-off of the layer of chromium through a selective chemical attack, in particular through the intermediary of an acid bath. This attack is such that it eliminates the metal or metal alloy layer 22 without damaging the surface 11 of the horological component, notably without damaging the layer of silicon dioxide according to this embodiment. The dissolving of the metal or metal alloy layer 22 at the same time induces the removal of the layer of material 8 situated outside of the cavity or cavities 7. In this step, the fact notably that the layer of material 8 does not totally cover the metal or metal alloy layer 22 over all of the surface 11 of the component makes it possible to minimize the time needed to perform this step. The final result is illustrated by FIG. 1g.

The metal or metal alloy layer 22 thus fulfils the sacrificial layer function, which allows the easy removal of the layer of material deposited outside of the cavities, the desired end result being to conserve this material only in the cavities.

Advantageously, the perfect covering of the layer of material 8 on the metal or metal alloy layer 22 present in the cavities 7 allows these layers not to be impacted by the removal step E5. Thus, these two layers 22, 8 remain present in the cavities 7. It should be noted that the metal or metal alloy layer 22 advantageously fulfils a second adhesion layer function for the layer of material 8 in the cavities, by improving the adhesion of the layer of material 8 on the component 1.

Moreover, to optimize the removal step described above, it is very advantageous for there to be a discontinuity of the metal or metal alloy layer 22 at the at least one cavity 7. Thus, it is advantageous for there to be no metal or metal alloy layer 22 deposited over all or part of the side walls 18 of the at least one cavity, notably not in the upper part of these side walls 18. In other words, the metal or metal alloy layer 22 extends only over the bottom 17 of the cavity 7 or does not extend over the side walls 18, or extends over a negligible height of the side walls 18, notably not in the upper part of the side walls. To facilitate this result, it is also advantageous for the at least one cavity 7 to itself have a discontinuity at the boundary between the surface 11 and the side walls 18 of the cavity 7. This is notably the case when the side walls 18 are vertical or substantially vertical. In addition, the thickness of the layer of material 8 is thick enough for it to be able to completely cover the metal or metal alloy layer 22 in the cavities 7, notably at least on the bottom 17 of the cavities 7, and to not have holes likely to allow acid to pass through during a chemical attack performed in this removal step. Thus, according to a preferred embodiment, the thickness of the layer of material 8 is at least 100 nm, notably is between 100 and 200 nm. It should be noted that the thickness of the layer of material 8 is preferentially greater than that of the metal or metal alloy layer 22. More generally, any configuration, combining all or part of the features proposed above, making it possible to render the metal or metal alloy layer 22 not accessible inside the at least one cavity 7, is highly advantageous to guarantee the non-removal of the two superposed layers 22, 8 at the at least one cavity.

Finally, the method can comprise an optional step consisting in detaching E6 the blanks 1a from the substrate 10a. To facilitate the implementation of this step, the component blank 1a can comprise a partially engraved break zone, notably as described in the document EP3632839A1.

Naturally, the composition of the metal or metal alloy layer 22 will be adapted on a case-by-case basis to that of the layer of material 8 selected, for example as a function of the material selected and/or the thickness thereof. The metal or metal alloy layer 22 will have a composition different from that of the layer of material 8 in the case where the latter is metal.

According to variant embodiments, the step consisting in depositing E4 a material consists of a step of application on the bottom 17 of the cavity or cavities 7 of a layer of material 8 which is a layer of a paint, applied by any technique known to the person skilled in the art, such as a spraying technique or through the use of a brush. Alternatively, a layer of a lacquer, of a varnish or of a composite material, in particular a luminescent composite material, can be applied.

The thickness of said layer of material 8 can subsequently match the depth of the cavity 7 in which it is deposited. In this particular case, the thickness of said layer of material 8 can preferentially be very slightly less than the depth of the cavity 7.

Note that, in all the embodiments and their variants, it is possible to perform the material deposition step E4 after the implementation of the step consisting in detaching E6 the blank 1a from the substrate 10a, notably in the context of a manual application of the layer of material 8 according to the embodiment described above.

Furthermore, in all the embodiments, all the steps could be implemented on a component blank 1a on its own, not linked to a substrate. They can also be implemented at different steps in the manufacturing of a horological component, that is to say on a blank of such a horological component, or during manufacturing, even directly on a finalized or quasi-finalized horological component.

Such a method is very particularly suited to the manufacturing of a spiral spring, by using the variant consisting in producing the cavity or cavities of the invention before engraving the coils, otherwise it would in practice be difficult to position a liquid resin on turns to engrave the cavities of the invention since the resin would flow between these coils, in the particular case in which the step E3 is a step of deep reactive ion etching.

Finally, it appears that the invention achieves the objects sought through the combination of the following two essential steps applied to at least a portion comprising a surface, in particular a top surface, of a horological component blank or of a horological component:
engraving E3 said surface of the blank or of the horological component to form at least one cavity;
depositing E4 a material in said at least one cavity to form a layer of material 8,
   an intermediate metal or metal alloy layer 22, serving as sacrificial layer and/or adhesion layer, being inserted between the surface 11 of the component and the layer of material 8.

In all the embodiments and their variants, the depth of at least one cavity, and preferably of all the cavities, is advantageously less than 10 μm, even less than 6 μm. This depth is, in addition, optionally greater than 3 μm. Thus, this depth can be between 3 μm and 10 μm, even between 3 μm and 6 μm. Surprisingly, it appears to the naked eye, for a horological component of small size such as a horological movement component like a spiral spring, that the contrast between at least one cavity 7 and the surface 11 is all the more marked when the depth of said at least one cavity 7 is small. That is all the more notable when the layer of material 8 is metal or a metal alloy and the component notably wholly or partly comprises silicon.

Furthermore, the depth of at least one cavity, and preferably of all the cavities, can also be greater than or equal to the thickness of a possible coating of silicon dioxide 13 present on said surface when the component only or partly comprises silicon. Such a coating of silicon dioxide can have a thickness of between 0.1 μm and 5 μm.

As a variant, particularly suitable if the component 1 is an external part component such as, for example, a bezel disk, in particular made of ceramic, the depth of at least one cavity, and preferably of all the cavities, is between 10 μm and 100 μm, even between 15 μm and 80 μm, even between 20 μm and 50 μm.

In the notable case of a horological movement component, at least one cavity, preferably all the cavities, can also have a length of at least 100 μm, even of at least 150 μm, even of at least 200 μm, even of at least 250 μm, in at least one direction. This length can be less than or equal to 800 μm, even less than or equal to 600 μm, even less than or equal to 500 μm, even less than or equal to 400 μm.

The material deposited in the at least one cavity can be a metal or a metal alloy. As a variant, it can be a paint, a lacquer, a varnish, a composite material, notably a luminescent composite material in particular, with, optionally, an intermediate adhesion metal layer.

In the embodiments and their variants, the material deposited in the at least one cavity advantageously has a thickness strictly less than the depth of the cavity. The deposit thickness can be greater than or equal to 100 nm. It can be between 100 nm and 1000 nm, advantageously between 100 nm and 200 nm. In particular, it can have a thickness equal to or substantially equal to the depth of the cavity. In addition, the sum of the thickness of the layer of material 8 and of the thickness of the metal or metal alloy layer 22 can be strictly less than the depth of the cavity or substantially equal to the depth of the cavity.

The invention applies particularly well to any horological movement component made of a micro-machinable material, that is to say one obtained from micro-manufacturing techniques, particularly those involving photolithography or those involving laser machining. Thus, such a horological movement component, in particular its general form, can for example be obtained, at least partially, by a deep reactive ion etching (acronym DRIE) step. In particular, such a horological movement component, particular its general form, can for example be obtained, at least partially, by UV-Liga (Llthographie Galvanik Abformung) technology.

The horological component according to the invention can wholly or partly comprise silicon, in any form. It can thus comprise monocrystalline silicon, regardless of its orientation, polycrystalline silicon, amorphous silicon, amorphous silicon dioxide, doped silicon regardless of the type and the level of doping. It can notably be manufactured from an SOI (silicon on insulator) substrate.

The horological component according to the invention can also comprise silicon carbide, glass, ceramic, quartz, ruby or even sapphire. Alternatively, it can be made of metal or a metal alloy, notably an at least partially amorphous metal alloy. For example, such a component can comprise nickel or nickel-phosphorus, or even steel, titanium, an alloy of gold, or a platinoid alloy.

Naturally, the invention is not limited to the embodiments described, and it is possible to imagine other embodiments, for example by combining embodiments and/or their variants. In particular, the engraving step E3 can combine the implementation of deep reactive ion etching by using a mask obtained by photolithography and laser etching, notably by a femtosecond laser.

It therefore appears that the invention achieves the objects sought by advantageously combining an engraving on a surface of a component and the partial, even total, filling thereof with a material, via a sacrificial metal or metal alloy layer. This combination makes it possible to form a legible marking, in particular a visible and attractive marking, even on a small surface, without impacting functionality of a horological movement component. Advantageously, this surface is a top surface or a visible surface, notably a surface that is visible when the component is assembled in a timepiece, in particular in a horological movement. Alternatively, this surface is a bottom surface or a non-visible surface.

The marking can be provided for decorative purposes. Alternatively or in addition, it can be provided for identification purposes. The variants of the method according to the invention, which involve a laser, in particular a femtosecond laser, are particularly advantageous in order to individualize the marking on a horological component, in particular a horological movement component, notably a particular spiral spring. The marking can for example form a serial number or a measurement result.

The invention relates also to a horological component obtained by the manufacturing method described previously. The component can be a horological movement component such as a lever, a wheel, for example a wheel of an escapement device, an anchor, a balance or a spiral spring, notably an oscillator spiral spring. As a variant, the horological component can be an external part component such as a bezel or a bezel disk, or a flange.

Notably, according to a particular embodiment, the component can be a horological movement component such as a spiral spring made of a micro-machinable material comprising a first portion forming a link part comprising a surface, in particular a top surface or a visible surface, and a second portion that is less rigid than the first portion comprising at least one blade spiral-wound forming a spring, the surface of the first portion comprising at least one cavity in which is deposited a material according to the invention. More generally, the horological component, or at least the portion comprising the surface affected by the invention, is advantageously based on a micro-machinable material, notably silicon-based, that is to say comprising by weight at least 50% micro-machinable material.

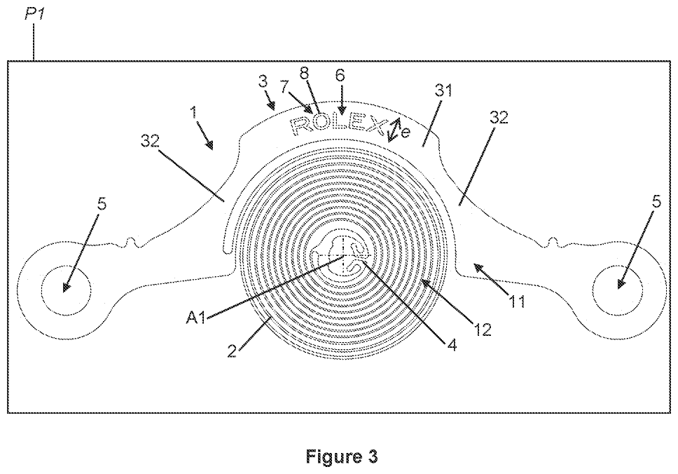

FIG. 3 thus illustrates a spiral spring obtained by a manufacturing method according to one of the embodiments described previously. It comprises at least one blade 2 of which the top surface 12 is situated in a plane P1, and of which the outer end is made of a piece with a link part 3, the rigidity of which is substantially greater than that of the at least one blade 2. The spiral spring 1 further comprises a collet 4 of axis A1, which is made of a piece with the internal end of the at least one blade 2.

The link part 3 comprises a first, central portion 31 in the form of a portion of a ring arranged around the blade 2, the angular extent of which is of the order of 100 degrees with respect to the axis A1. This link part 3 also comprises two bent portions 32 disposed on either side of the first, central portion 31, each of which comprises an element 5 for positioning and/or fixing said spiral spring, which here takes the form of an opening.

The link part 3 has the particular feature of comprising patterns (or indications) 6 applied to its top surface 11, positioned in the plane P1, notably on its central portion 31. The top surface 11 is, here, formed in continuity with the top surface 12 of the at least one blade 2 of the spiral spring.

The patterns 6 result from the method described previously, and comprise cavities 7 formed from the top surface 11, in which a layer of material 8 is deposited.

The extent e of the patterns, that is to say also the extent of the cavities, measured radially relative to the axis A1, can be greater than 100 μm, even greater than 150 μm, even greater than 200 μm, even greater than 250 μm. Such patterns or indications 6 can thus be visible or legible once the spiral spring 1 is mounted in an assembled balance, which is itself assembled in a horological movement.

This spiral spring can be a spiral spring for a sprung balance. It can be of a single piece. It can be made of silicon, and it can be manufactured from a substrate of silicon or from an SOI (silicon on insulator) substrate. The surface considered by the invention can be covered with a coating of silicon dioxide.

The invention relates also to a timepiece comprising such a horological component. It relates in particular to a horological movement comprising such a horological movement component.

1. A method for manufacturing a horological component comprising at least one portion comprising a surface, wherein the method comprises:
engraving the surface of the horological component or of a blank of the horological component to form at least one cavity comprising side walls and a bottom;
depositing a metal or metal alloy layer on the surface, both in the at least one cavity and outside of the at least one cavity, and not extending over the side walls or not extending over the entire height of the side walls;
depositing a material on the metal or metal alloy layer, at least within the at least one cavity, to form a layer of material, the material being different from the metal or the metal alloy of the metal or metal alloy layer, the metal or metal alloy layer forming an adhesion layer of the layer of material, and a thickness of the layer of material being greater than a thickness of the metal or metal alloy layer;
removing the metal or metal alloy layer deposited outside of the at least one cavity, subsequent to the depositing of the material in the at least one cavity.

2. The method according to claim 1, wherein a depth of the at least one cavity is less than 10 μm.

3. The method according to claim 1, wherein a depth of the at least one cavity is in a range of from 10 μm to 100 μm.

4. The method according to claim 1, wherein a depth of the at least metal or metal alloy of the metal or metal alloy layer is made of at least one metal selected from the group consisting of aluminium, chromium, and titanium, or of at least one alloy of at least one metal selected from the group consisting of aluminium, chromium, and titanium.

5. The method according to claim 1, wherein the depositing of the material in the at least one cavity comprises depositing at least one selected from the group consisting of a metal, a metal alloy, a paint, a lacquer, a varnish, and a composite material.

6. The method according to claim 1, wherein
the engraving of the surface forms at least one cavity comprising a bottom and side walls at right angles to the bottom, and/or
the depositing of the metal or metal alloy layer is performed so that the metal or metal alloy layer does not extend over the side walls or does not extend over an entire height of the side walls.

7. The method according to claim 1, wherein the depositing of the metal or metal alloy layer and/or the depositing of the material in the at least one cavity is performed by a directional deposition process.

8. The method according to claim 1, wherein the portion of the horological component comprising the surface comprises a micro-machinable material or a metal or a metal alloy.

9. The method according to claim 1, wherein the portion comprising the surface comprises silicon, and wherein the method comprises oxidizing the silicon, forming a layer of silicon dioxide on the surface, both in the at least one cavity and outside of the at least one cavity,
wherein the oxidizing is performed after the engraving of the surface, and/or
wherein the oxidizing is performed before the depositing of the metal or metal alloy layer on the surface.

10. The method according to claim 1, wherein the engraving of the surface of the portion of the horological component or of a blank of the horological component comprises implementing a deep reactive ionic engraving through a mask obtained by photolithography and/or a laser engraving.

11. The method according to claim 1, comprising engraving an outline of the horological component, wherein
the engraving of the surface of the portion is performed in a same operation as the engraving of the outline of the horological component, and/or
the engraving of the surface of the portion is performed before the engraving of the outline of the horological component, and/or
the engraving of the surface of the portion comprises positioning a first mask on a substrate performing the engraving of the at least one cavity from the first mask, and positioning a second mask distinct from the first mask on the substrate, and etching an outline of the blank of the horological component from the second mask.

12. Method for manufacturing a horological component according to claim 1, comprising between the depositing of the metal or metal alloy layer and the depositing the material on the metal or metal alloy layer, an intermediate depositing of a mask on the metal or metal alloy layer, the mask comprising at least one opening superposed on the at least one cavity, with a surface area greater than or equal to the surface area of the cavity so as not to cover the at least one cavity.

13. The method according to claim 1, wherein the horological component is a movement component or an external part component.

14. A horological component comprising at least one first portion comprising a surface, wherein the horological component comprises:
at least one cavity comprising side walls and a bottom, arranged in the surface,
a metal or metal alloy layer arranged on the bottom of the cavity and not extending over the side walls or not extending over an entire height of the side walls, and
a layer of material arranged on the metal or metal alloy layer at least in the at least one cavity, the material being different from the metal or the metal alloy of the metal or metal alloy layer,
wherein the metal or metal alloy layer forming an adhesion layer of the layer of material,
wherein a thickness of the layer of material is greater than a thickness of the metal or metal alloy layer.

15. The horological component according to claim 14, wherein
the thickness of the metal or metal alloy layer is less than or equal to 100 nm, and/or
the thickness of the layer of material is in a range of from 100 nm and to 200 nm, and/or
a depth of the at least one cavity is less than 10 μm, and/or
a sum of the thickness of the layer of material and the thickness of the metal or metal alloy layer is less than a depth of the cavity, and/or
an extent of the at least one cavity is greater than 100 μm.

16. The method according to claim 5, wherein the depositing of the material in the at least one cavity comprises depositing a luminescent composite material.

17. The method according to claim 6, wherein the depositing of the metal or metal alloy layer is performed so that the metal or metal alloy layer does not extend in an upper part of the side walls.

18. The method according to claim 6, wherein the depositing of the metal or metal alloy layer is performed so that the metal or metal alloy layer extends only over the bottom of the at least one cavity.

19. The method according to claim 7, wherein the depositing of the metal or metal alloy layer and/or the depositing of the material in the at least one cavity is performed by a physical vapour deposition (PVD).

20. The method according to claim 7, wherein the depositing of the metal or metal alloy layer and/or the depositing of the material in the at least one cavity is performed by electron beam evaporation (EBE).
